(19) United States
(12) Patent Application Publication
(10) Pub. No.: US 2023/0339750 A1
(43) Pub. Date: Oct. 26, 2023

(54) DIELECTRIC BARRIER DISCHARGE PLASMA SYSTEM AND METHOD FOR IN-SITU HYDROGEN PEROXIDE PRODUCTION

(71) Applicant: UNIVERSITY OF SOUTH CAROLINA, COLUMBIA, SC (US)

(72) Inventors: MALIK M. TAHIYAT, COLUMBIA, SC (US); TANVIR I. FAROUK, COLUMBIA, SC (US)

(21) Appl. No.: 18/302,078

(22) Filed: Apr. 18, 2023

Related U.S. Application Data
(60) Provisional application No. 63/333,227, filed on Apr. 21, 2022.

(51) Int. Cl. B01J 19/08; C01B 15/027; B01J 19/00

(52) U.S. Cl. CPC C01B 15/027; B01J 19/0033; B01J 19/088; B01J 2219/0801; B01J 2219/083; B01J 2219/0841; B01J 2219/0869; B01J 2219/0875; B01J 2219/0896

(57) ABSTRACT

The disclosure deals with system/apparatus and corresponding and/or associated method for an open plasma reactor assembly provided to study pulsed reactive species produced in a dielectric barrier discharge (DBD) in He—H₂O and He—H₂O—O₂ mixture in atmospheric conditions using photo fragmentation laser-induced fluorescence (PFLIF). The objective is to detect and quantify hydroxyl radicals and hydrogen peroxide produced in the DBD. An OH laser-induced fluorescence (LIF) signal is acquired from LIF (using 282 nm laser) whereas LIF from OH generated from H₂O₂ is measured by from the PFLIF signal (using 213 nm+ 282 nm lasers). A known concentration of H₂O₂ in He serves to calibrate for H₂O₂ while the OH is calibrated with a chemical model. For both gas mixtures, there is both OH and H₂O₂ production in the discharge, while the H₂O₂ concentration was noticeably increased for the added O₂ case.

### PRIORITY CLAIM

The present application claims the benefit of priority of U.S. Provisional Pat. Application No. 63/333,227, titled Dielectric Barrier Discharge Plasma System For In-Situ Hydrogen Peroxide Production, filed Apr. 21, 2022, and which is fully incorporated herein by reference for all purposes.

### STATEMENT REGARDING SPONSORED RESEARCH OR DEVELOPMENT

This invention was made with government support under Grant No. 2029425, awarded by NSF. The government has certain rights in the invention

### BACKGROUND OF THE PRESENTLY DISCLOSED SUBJECT MATTER

The disclosure deals generally with dielectric barrier discharge plasma system and corresponding method for in-situ hydrogen peroxide production, and more particularly with system/apparatus and corresponding and/or associated method for an open plasma reactor assembly provided to study pulsed reactive species produced in a dielectric barrier discharge (DBD) in He—H₂O and He—H₂O—O₂ mixture in atmospheric conditions using photo fragmentation laser-induced fluorescence (PFLIF). The objective is to detect and quantify hydroxyl radicals and hydrogen peroxide produced in the DBD.

In recent times, nonthermal plasma (NTP) discharges in presence of water have found widespread scope of research in environmental [1-3], biomedical [4-6], and catalysis [7-9] applications. The primary reason for this immense interest is the production of reactive oxidizing species from NTP discharge in humid medium, namely OH and H₂O₂, which take active roles in the aforementioned physicochemical processes. In waste water treatment, ozone and OH are the primary species responsible for the oxidation of organic contaminants in liquid [1] and gaseous states [3]. Both OH and H₂O₂ are prominent oxidizers in plasma-activated water that has shown to possess antibacterial effects [2, 4]. OH, H₂O₂ and O₃ generated from NTP via dielectric barrier discharge (DBD) was also found to promote proliferation when NTP is applied to mammalian cells [5]. The OH radicals generated from NTP has also shown promise in the treatment of cancer cells [6]. It has also been observed that plasma-catalytic destruction of volatile organic compounds (VOCs) increased in efficiency due to the formation of OH in the presence of humid air [7, 9]. Hydroxylation reactions are also found to be one of the primary pathways for the catalytic breakdown of pharmaceutical wastes [8]. Thus, to understand discharge chemistry and conditions responsible for generation of these oxidizing species, it is imperative to know their respective discharge distribution for different operating parameters.

Most experimental efforts in the literature have attempted to use laser-induced fluorescence (LIF) to quantify OH distribution in nano-second pulsed (NSP) discharges. However, these attempts have usually involved trace water vapor in carrier gases: nitrogen [10], helium [11-13], argon [12], and synthetic air [14, 15]. In most cases, a frequency-doubled dye laser- synchronized with a high voltage pulsar- is used to generate 282 nm photons, which excite OH in a timed discharge; the resultant fluorescence is captured with an ICCD (intensified charged-coupled device) camera with a 313 nm optical filter coupled with a spectrometer [13]. The OH concentration is usually found via a chemical model or UV absorption spectroscopy.

Optical emission spectroscopy (OES) of pulsed corona discharge in water has been studied previously for both liquid and bubble modes [16]. Stark broadening of the H_{β} line was used to measure electron number density (nₑ) and the gas temperature (T_{g}) was measured from the rotational temperature of N₂(C—B) lines. Both nₑ, emission intensities of OH, H, and O as well as chemical reactivity -deduced by measuring the production rate of H₂O₂— were found to be significantly larger in the liquid state than in the bubble state whereas T_{g} was ~ 300 K higher in the liquid mode [16].

OH number density measurements in the afterglow of an NSP discharge in He + trace H₂O were compared from three different techniques: UV absorption, LIF calibrated with Rayleigh scattering and chemical modeling and were found to correspond within experimental uncertainty [17]. The spatial density distribution of OH in an NSP discharge in He—H₂O mixture was studied with LIF for two different discharge power densities [13]. It was observed that for low power, OH is mostly concentrated in the middle of the discharge whereas for the higher power, OH is mostly present at the periphery and the discharge core appeared dissociated. It is deduced from a chemical model that in the latter case, the dissociated core results from charge exchange and dissociative recombination of atomic ions and OH⁺. OH density in NSP in the N₂—H₂O mixture also shows a drop in OH at the core, which is expected to be due to a higher OH decay rate at the core due to kinetics involving larger local densities of N and N⁺ [10].

For a similar discharge geometry and gas mixture, it was observed that the maximum OH density is found in the afterglow at 1-2 µs after the discharge current pulse [11]. This OH spike in the afterglow is attributed to the charge transfer reactions from atomic ions to H₂O and electron-water ion recombination reactions. The absolute number density of OH has also been measured by broadband UV absorption spectroscopy for He—H₂O mixture in RF glow discharge, using 310 nm UV LED [18]. For different humidity and power densities, the OH number densities were found to be in the range of 10¹⁹ -10²⁰ m⁻³ for temperatures between 345-410 K.

Discharge morphology of DBD with H₂O in presence of He and Ar was studied with ICCD imaging and broadband absorption [12]. The difference in OH density with respect to H₂O concentration for the two gases is attributed to the change in the number of micro discharge filaments, surface charge intensity, and kinetic losses. LIF measurements in a pulsed arc discharge in H₂O/O₂/N₂ mixture, showed that OH increased with both humidity and oxygen content due to the formation of additional reaction pathways [14]. Spatial and temporal temperature measurements for a pulsed positive corona discharge for a similar gas mixture showed that, in the afterglow, the temperature at the anode is higher than in the rest of the discharge volume [15]. This is attributed to the lower OH decay rate at the anode owing to the comparative lack of OH forming reaction pathways in the rest of the discharge volume. In a nozzle-to-plane dc streamer corona discharge, 2-D LIF shows that OH radicals are produced mostly within the streamers and the shape of these streamers is affected by the presence of metastables from associated carrier gases [19].

LIF measurements in atmospheric pressure DBD in He—H₂O mixture have shown that comparative dependence of OH density is greater on the water vapor content than on discharge current; the maximum value at saturated vapor pressure was found to be 10¹³ cm⁻³ [20]. Even though LIF measurements of OH and T_{g} in trace water in presence of He, N₂ and O₂ has been well researched in pulsed dc systems, similar measurements of OH and H₂O₂ in high water content in a DBD system has been scarce. Moreover, most chemical models used to calculate OH density does not include the OH decay recombination reactions to form H₂O₂.

Since H₂O₂ is not known to fluoresce in any known wavelength, photofragmentation LIF (PF-LIF) is adopted to detect and quantify H₂O₂. In PFLlF, a pump photon (213 nm or 266 nm) photo dissociates a parent molecule (in this case, H₂O₂) into fragments (i.e. OH) that are detected by a probe photon (282 nm) using LIF [21, 22]. The 213 nm is generated from the fifth harmonic of an Nd: YAG laser, whereas 266 nm is generated from a frequency quadrupled Nd: YAG laser. Previous studies in combustion physics measured H₂O₂ by using a 266 nm laser to photo-dissociate each H₂O₂ molecule into two OH radicals which are, in turn, excited by LIF, and the resulting signals are detected [23, 24]. A technique for measuring both H₂O and H₂O₂ had been studied by combining PF-LIF and Two-Photon LIF (2P-LIF): KrF excimer laser at 248.28 nm is used to induce broadband fluorescence (400-500 nm) from H₂O molecules via 2P-LIF and simultaneously photo dissociate H₂O₂; 281.9 nm from a frequency-doubled dye laser is used to fluoresce resulting OH after 50 ns [22]. PF-LIF signal yield from H₂O at room temperatures is also deemed negligible compared to that from H₂O₂. Despite multiple applications in combustion physics, PF-LIF to detect H₂O₂ in non-thermal plasma is virtually nonexistent in literature and thus, will contribute to a new development in this area.

### SUMMARY OF THE PRESENTLY DISCLOSED SUBJECT MATTER

The disclosure deals generally with dielectric barrier discharge plasma system and corresponding method for in-situ hydrogen peroxide production, and more particularly with system/apparatus and corresponding and/or associated method for an open plasma reactor assembly provided to study pulsed reactive species produced in a dielectric barrier discharge (DBD) in He—H₂O and He—H₂O—O₂ mixture in atmospheric conditions using photo fragmentation laser-induced fluorescence (PFLIF). The objective is to detect and quantify hydroxyl radicals and hydrogen peroxide produced in the DBD.

The presently disclosed subject matter devises a cost-effective method for producing OH radicals and hydrogen peroxide in-situ solely from highly concentrated water vapor in a carrier gas and electricity. The presently disclosed innovations can be used in different sectors: medical, agriculture, and cleanrooms, as well as in research communities as a scientific diagnostics tool for analyzing active species produced in a plasma afterglow.

The presently disclosed subject matter offers various competitive advantages over prior work. For example, many of the hydrogen peroxide (H₂O₂) vapor generators, which currently exist in the market, merely use flash vaporization of a liquid form of H₂O₂ to form H₂O₂ vapor. Some of these generators can only operate in ultra high vacuum. Other existing generators that produce H₂O₂ from water employ physical membranes, which are expensive and have to be replaced at regular intervals.

The presently disclosed subject matter produces H₂O₂ from water vapor and electricity in-situ which circumvents these issues. Also, the physical dimensions and the maximum operable distance of the unit from the substrate allows it to be used in laser diagnostics for quantification and detection of active species produced in the plasma discharge. The data generated from such diagnostics can be used by the research community to perform model validation. According to Global Market Insights, the hydrogen peroxide market size was valued at around $4.8 billion in 2019 and will exhibit a growth rate of over 5.7% CAGR from the period of 2020 to 2026.

In some presently disclosed embodiments, an OH laser-induced fluorescence (LIF) signal is acquired from LIF (using 282 nm laser) whereas LIF from OH generated from H₂O₂ is measured by from the PFLIF signal (using 213 nm+ 282 nm lasers). A known concentration of H₂O₂ in He serves to calibrate for H₂O₂ while the OH is calibrated with a chemical model. For both gas mixtures, there is both OH and H₂O₂ production in the discharge, while the H₂O₂ concentration was noticeably increased for the added O₂ case.

In some other presently disclosed embodiments, a device uses an electric field to initiate an electrical breakdown in gas with high water vapor content. Electrical breakdown of water molecules forms hydroxide (OH) radicals among other active species. These OH radicals combine in pairs to form hydrogen peroxide (H₂O₂). Thus, H₂O₂ is formed in-situ the reactor itself only using water vapor and electricity.

For some present embodiments, a presently disclosed mechano-chemical electrode has been designed and integrated to a dielectric barrier plasma discharge driven by a pulsing power source. The plasma source allows in-situ production of OH and H₂O₂ that are very efficient and effective oxidizer.

Per the present disclosure, pulsed dielectric barrier discharge in He-H₂O mixture has been studied in atmospheric air conditions using spatially resolved photo fragmentation laser induced fluorescence. The primary goals were to detect and quantify hydroxyl radicals and hydrogen peroxide produced in the discharge afterglow. The OH LIF signal is acquired from LIF using a OH excitation beam originating from a dye laser. The H₂O₂ is photodissociated into two OH with a photofragmentation laser beam and the resulting OH are excited with the OH excitation beam as well (PFLIF signal). OH generated only from H₂O₂ is measured by subtracting the OH LIF signal from the PFLIF signal. H₂O₂ is calibrated using metered mixtures of H₂O₂ in He, whereas the OH was calibrated with a chemical model. It is observed that both OH and H₂O₂ have distinct presences in the afterglow of the discharge, with H₂O₂ having the longer residence time of the two. This may indicate that the primary sink route for OH radicals may be recombination reactions, whereas for H₂O₂, it is the ambipolar and the convective losses since unlike OH, H₂O₂ is not an active free radical. Increasing voltage and/or pulse repetition frequency did not have any significant variation. When O₂ was added as an admixture to He—H₂O, it was observed that the H₂O₂ density increased. Since this phenomenon is observed in the afterglow it might be reasonable to suppose that such kinetics involves heavy particle reactions including charge transfer, recombination, and dissociative recombination reactions involving •O radicals, H₂O, H₂O+ and •OH.

In one exemplary embodiment disclosed herewith, a method for in-situ hydrogen peroxide production from water vapor and electricity, comprises providing an open plasma reactor assembly having a feed end and a plasma reaction end; introducing a flow of a mixture of He and water (H2O) into the assembly feed end; and using high voltage pulses with the open plasma reactor assembly to produce hydrogen peroxide (H2O2) in a plasma discharge at the plasma reaction end.

Another exemplary such method relates to methodology for the production of reactive oxidizing species in a plasma discharge, comprising generating nonthermal plasma (NTP) discharges in the presence of water and He for in-situ production of hydrogen peroxide (H2O2) in the NTP discharge.

It is to be understood that the presently disclosed subject matter equally relates to associated and/or corresponding devices and/or systems. One exemplary such system for in-situ hydrogen peroxide production from water vapor and electricity, comprises an open plasma reactor assembly having a powered electrode having a feed end and a plasma reaction end; a flow of a mixture of He and water (H2O) controllably fed into the assembly feed end; and a pulser for selectively providing high voltage pulses to the powered electrode for producing hydrogen peroxide (H2O2) in a plasma discharge at the electrode plasma reaction end.

Other example aspects of the present disclosure are directed to systems, apparatus, tangible, non-transitory computer-readable media, user interfaces, memory devices, and electronic devices for control of production of hydrogen peroxide. To implement methodology and technology herewith, one or more processors may be provided, programmed to perform the steps and functions as called for by the presently disclosed subject matter, as will be understood by those of ordinary skill in the art.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1(a) illustrates a schematic of a presently disclosed experimental setup for working with the presently disclosed production subject matter;

FIGS. 1(b), 1(c), and 1(d) illustrate side, cross-sectional, and bottom detailed configuration views, respectively, of an exemplary electrode for use in the presently disclosed subject matter;

FIG. 2 illustrates an exemplary laser diagnostics setup;

FIGS. 3(a) and 3(b) comprise exemplar discharge photographs of dielectric barrier discharge (DBD) (i.e., discharge photographs of He—H2O discharge) in humid helium;

FIGS. 4(a) and 4(b) illustrate discharge photographic graph results for OH mole fraction (ppm) along the x-axis thereof for, respectively, pure He and He+5%O₂, for five pulses at a time t = 20000 µs;

FIGS. 4(c) and 4(d) illustrate discharge photographic graph results for H₂O₂ mole fraction (ppm) along the x-axis thereof for, respectively, pure He and He+5%O₂, for five pulses at a time t = 20000 µs;

FIGS. 5(a) and 5(b) illustrate discharge photographic graph results for OH mole fraction (ppm) along the x-axis thereof for, respectively, pure He and He+5%O₂, for ten pulses at a time t = 20000 µs;

FIGS. 5(c) and 5(d) illustrate discharge photographic graph results for H₂O₂ mole fraction (ppm) along the x-axis thereof for, respectively, pure He and He+5%O₂, for ten pulses at a time t = 20000 µs;

FIGS. 6(a) and 6(b) illustrate discharge photographic graph results for OH mole fraction (ppm) along the x-axis thereof for, respectively, pure He and He+5%O₂, for five pulses at a time t = 10 ms;

FIGS. 6(c) and 6(d) illustrate discharge photographic graph results for H₂O₂ mole fraction (ppm) along the x-axis thereof for, respectively, pure He and He+5%O₂, for five pulses at a time t = 10 ms;

FIGS. 7(a) and 7(b) illustrate discharge photographic graph results for OH mole fraction (ppm) along the x-axis thereof for, respectively, pure He and He+5%O₂, for ten pulses at a time t = 10 ms;

FIGS. 7(c) and 7(d) illustrate discharge photographic graph results for H₂O₂ mole fraction (ppm) along the x-axis thereof for, respectively, pure He and He+5%O₂, for ten pulses at a time t = 10 ms;

FIG. 8(a) illustrates discharge photographic graph results for OH mole fraction (ppm) along the x-axis thereof for pure He for 1 slm, 2 slm, 3 slm, 4 slm, and 5 slm flow rates, respectively, for time t = 5000 µs;

FIG. 8(b) illustrates discharge photographic graph results for H₂O₂ mole fraction (ppm) along the x-axis thereof for pure He for 1 slm, 2 slm, 3 slm, 4 slm, and 5 slm flow rates, respectively, for time t = 5000 µs;

FIG. 9(a) illustrates discharge photographic graph results for OH mole fraction (ppm) along the x-axis thereof for He+5%O₂ for 1 slm, 2 slm, 3 slm, 4 slm, and 5 slm flow rates, respectively, for time t = 5000 µs;

FIG. 9(b) illustrates discharge photographic graph results for H₂O₂ mole fraction (ppm) along the x-axis thereof for He+5%O₂ for 1 slm, 2 slm, 3 slm, 4 slm, and 5 slm flow rates, respectively, for time t = 5000 µs;

FIG. 10(a) illustrates discharge photographic graph results for pure He at first through fifth pulses, respectively; and

FIG. 10(b) illustrates discharge photographic graph results for He+5%O₂ at first through fifth pulses, respectively.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to system/apparatus and corresponding and/or associated method for an open plasma reactor assembly provided to study pulsed reactive species produced in a dielectric barrier discharge (DBD) in He—H₂O and He—H₂O—O₂ mixture in atmospheric conditions using photo fragmentation laser-induced fluorescence (PFLIF). An objective is to detect and quantify hydroxyl radicals and hydrogen peroxide produced in the dielectric barrier discharge (DBD). An OH laser-induced fluorescence (LIF) signal is acquired from LIF (using 282 nm laser) whereas LIF from OH generated from H₂O₂ is measured by from the PFLIF signal (using 213 nm+ 282 nm lasers). A known concentration of H₂O₂ in He serves to calibrate for H₂O₂ while the OH is calibrated with a chemical model. For both gas mixtures, there is both OH and H₂O₂ production in the discharge, while the H₂O₂ concentration was noticeably increased for the added O₂ case.

Per the presently disclosed subject matter, we studied the generation of OH and H₂O₂ from atmospheric pressure dielectric barrier discharge in two different carrier gas mixtures: He— H₂O and He—H₂O—O₂ mixtures at the highest attainable water vapor concentration at 293 K. The densities of H₂O₂ and OH were measured using PF-LIF and LIF respectively. He is used as the carrier gas since it has lesser reaction pathways that involve OH kinetics that is expected to facilitate modeling the discharge [11] and being the only monatomic inert gas, possesses lower quenching ability than other polyatomic inert gases. The H₂O₂ concentration was calibrated by flowing a He—H₂O₂ mixture. The OH concentration was calibrated from a chemical model. The results from these experiments will serve as an effective measurement for the in-situ production of active species from high water vapor concentration by the designed electrode assembly. It will also provide data for model validation for similar discharge configurations, which are not readily available in the literature.

### Experimental Setup

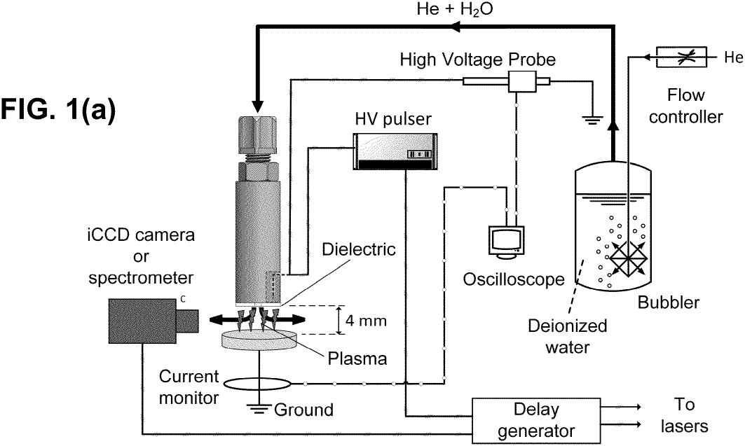

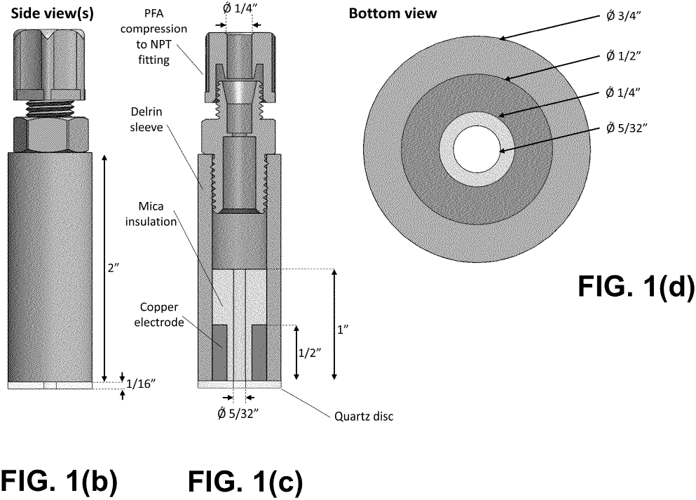

FIG. 1(a) illustrates a schematic of a presently disclosed experimental setup for working with the presently disclosed production subject matter. FIGS. 1(b), 1(c), and 1(d) illustrate side, cross-sectional, and bottom detailed configuration views, respectively, of an electrode for use in the presently disclosed subject matter.

With reference to the schematic of the experimental setup as shown in FIG. 1(a), He gas is continuously passed through an MKS (MKS Instruments) mass flow controller at 500 sccm (standard cubic centimeter per minute) following a bubbler containing filtered water in a water bath (not shown here) at 298 degrees K. The resultant He—H₂O mixture flows into the top of the electrode (as shown) through the center and forms a stagnation plane in the 4 mm interelectrode spacing between the quartz dielectric (disc on the bottom of the electrode) and a grounded SS (stainless steel) plate (not shown here). The water vapor concentration is calculated by the assumption that the He—H₂O mixture flowing out of the electrode nozzle in the bottom is saturated with water vapor at 298 degrees K. An Eagle Harbor Technologies Model No. NSP-20-30F nanosecond pulser, operating at 1 kHz, is used to provide high voltage pulses to the powered electrode. The frequency of the burst mode is controlled by a function generator synchronized with a delay generator, as illustrated per FIG. 1(a). The voltage and current profiles may be recorded such as with a North Star PVM-4 high voltage probe and Pearson 6015 current monitor.

The detailed configuration of the powered electrode is shown in FIG. 1(b). It consists of a powered copper cylinder housed concentrically in a Delrin cylindrical block (with Delrin sleeves comprising known compression sleeves, a form of plastic O-rings used when connecting PEX or other plastic pipe to a compression fitting). A tapered mica cylinder is drilled into the copper to induce structural rigidity as well as discharge leaking from the sides of the copper. A concentric channel is drilled into the mica as well to flow the He—H₂O mixture. Finally, a quartz dielectric with a center hole is fused to the copper and Delrin using an adhesive with high dielectric strength.

### Laser Diagnostics Setup

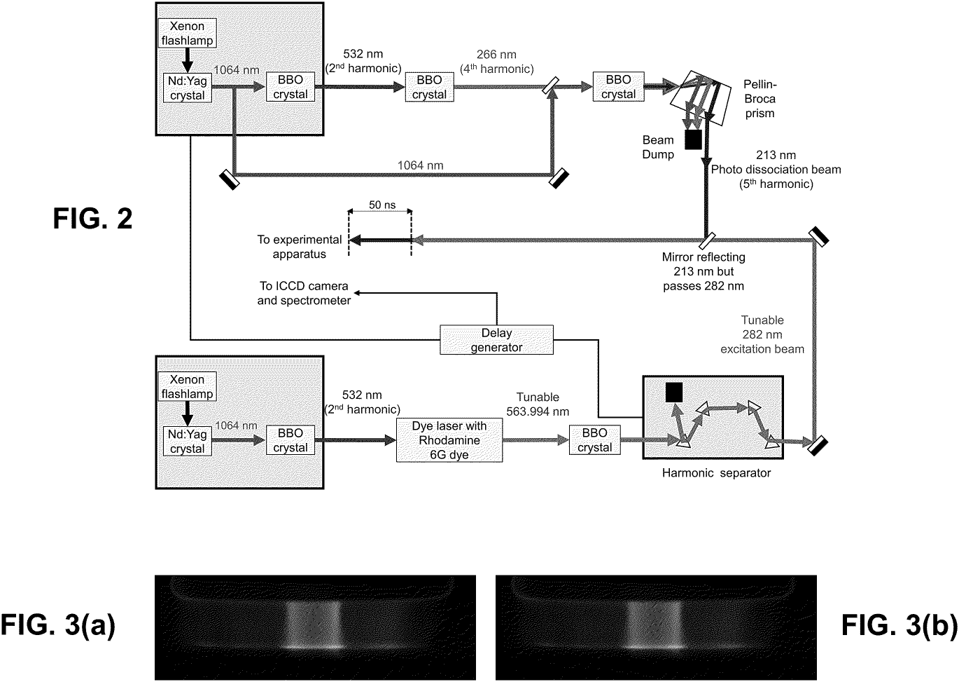

FIG. 2 illustrates an exemplary laser diagnostics setup, in particular illustrating an exemplary laser generation system for Laser-induced fluorescence (LIF) and photofragmentation laser induced fluorescence (PFLIF) diagnostics.

More specifically, per the exemplary arrangement illustrated, the 5^{th} harmonic from Nd:YAG laser (Quanta Ray Pro) was used to generate the photo dissociation beam (213 nm) to fragment H₂O₂ to OH radicals. A tuned frequency-doubled dye laser (Sirah Precision Scan), with Rhodamine 6 G dye, pumped by an Nd:YAG laser (Quanta Ray Pro) was used to generate an excitation beam (282.594 nm), which, induced fluorescence from OH at 315 nm. The benefits of using this transition are mentioned in [13]. To measure OH generated solely from the DBD, the 213 nm beam was blocked with a beam dump. The laser pulses were produced at a frequency of 10 Hz. As generally understood regarding Nd:YAG lasers are Neodymium (Nd) where YAG represents Yttrium Aluminum Garnet crystals to generate the laser. YAG lasers work by focusing a very brief pulse of laser light at a precise point in 3D space, to create a small concentrated light energy or an explosion of plasma for a very brief time. Details as recited in FIG. 2 are intended as incorporated into this disclosure.

### Results

Absolute calibration of H₂O₂ PF-LIF signals is performed using a He—H₂O—H₂O₂ reference mixture, which consists of a 2 slm (standard liters per minute flow rate) He bubbling through a 50%(wt) hydrogen peroxide solution, maintained at 293 degrees K by a water bath. The reference concentration of H₂O and H₂O₂ in the vapor phase is calculated using Raoult’s law by considering that the mixture is saturated with 50%(wt) hydrogen peroxide at 298 degrees K. This gives an H₂O concentration of 2.05% and H₂O₂ concentration to be 0.09% in the vapor phase. For He bubbling through H₂O only, the reference concentration of H₂O in the vapor phase is calculated to be 3.13%. The H₂O₂ concentration generated in the plasma is calculated by comparing the photofragmentation LIF signal from the plasma discharge to the photofragmentation LIF signal from the reference mixture of H₂O—H₂O₂. The OH concentration is calculated by measuring the OH LIF decay and a chemical model.

### Exemplar Discharge Photographs of He—H2O Discharge

FIGS. 3(a) and 3(b) comprise exemplar discharge photographs of dielectric barrier discharge (DBD) (i.e., discharge photographs of He—H2O discharge) in humid helium. As seen, a distinct core is visible along with a weaker surrounding discharge. It is observed that the typical average OH concentration in the afterglow is ~ 1.5 ppm and the H₂O₂ concentration is around 20 ppm. With the addition of O₂, the concentration of OH decreased to ~0.5 ppm; however, the H₂O₂ concentration increased to ~35 ppm.

### Additional Results

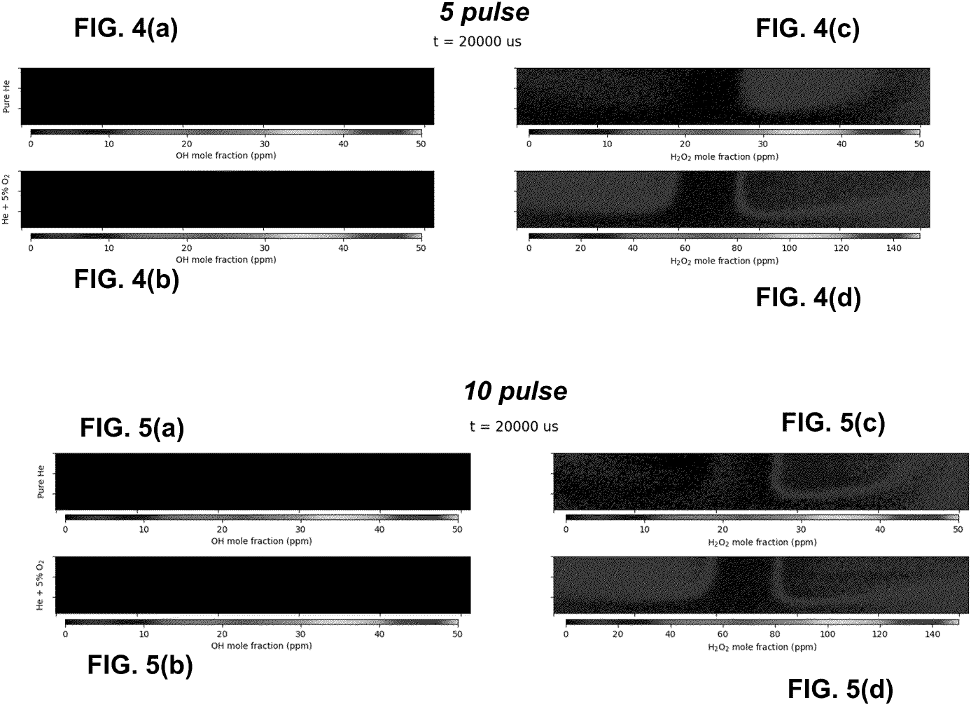

FIGS. 4(a) through 10(b) illustrate additional exemplary discharge photographs of dielectric barrier discharge (DBD) under various conditions of examining results obtained relative to use of the in-situ hydrogen peroxide (H₂O₂) production otherwise disclosed herein. In particular, FIGS. 4(a) and 4(b) illustrate discharge photographic graph results for OH mole fraction (ppm) along the x-axis thereof for, respectively, pure He and He+5%O₂, for five pulses at a time t = 20000 µs. Similarly, FIGS. 4(c) and 4(d) illustrate discharge photographic graph results for H₂O₂ mole fraction (ppm) along the x-axis thereof for, respectively, pure He and He+5%O₂, for five pulses at a time t = 20000 µs.

FIGS. 5(a) and 5(b) illustrate discharge photographic graph results for OH mole fraction (ppm) along the x-axis thereof for, respectively, pure He and He+5%O₂, for ten pulses at a time t = 20000 µs. Similarly, FIGS. 5(c) and 5(d) illustrate discharge photographic graph results for H₂O₂ mole fraction (ppm) along the x-axis thereof for, respectively, pure He and He+5%O₂, for ten pulses at a time t = 20000 µs.

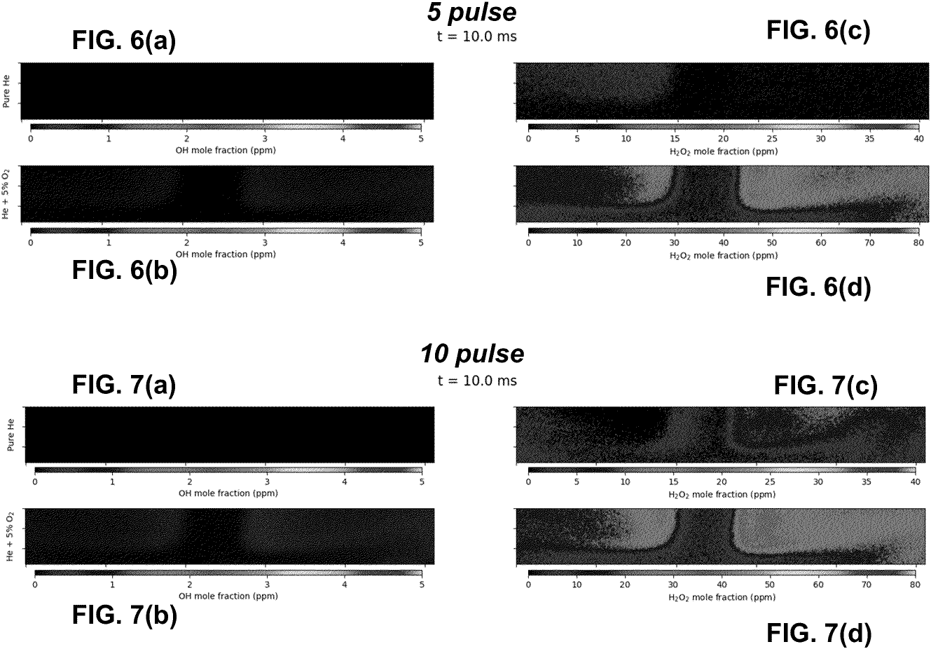

FIGS. 6(a) and 6(b) illustrate discharge photographic graph results for OH mole fraction (ppm) along the x-axis thereof for, respectively, pure He and He+5%O₂, for five pulses at a time t = 10 ms. Similarly, FIGS. 6(c) and 6(d) illustrate discharge photographic graph results for H₂O₂ mole fraction (ppm) along the x-axis thereof for, respectively, pure He and He+5%O₂, for five pulses at a time t = 10 ms.

FIGS. 7(a) and 7(b) illustrate discharge photographic graph results for OH mole fraction (ppm) along the x-axis thereof for, respectively, pure He and He+5%O₂, for ten pulses at a time t = 10 ms. Similarly, FIGS. 7(c) and 7(d) illustrate discharge photographic graph results for H₂O₂ mole fraction (ppm) along the x-axis thereof for, respectively, pure He and He+5%O₂, for ten pulses at a time t = 10 ms.

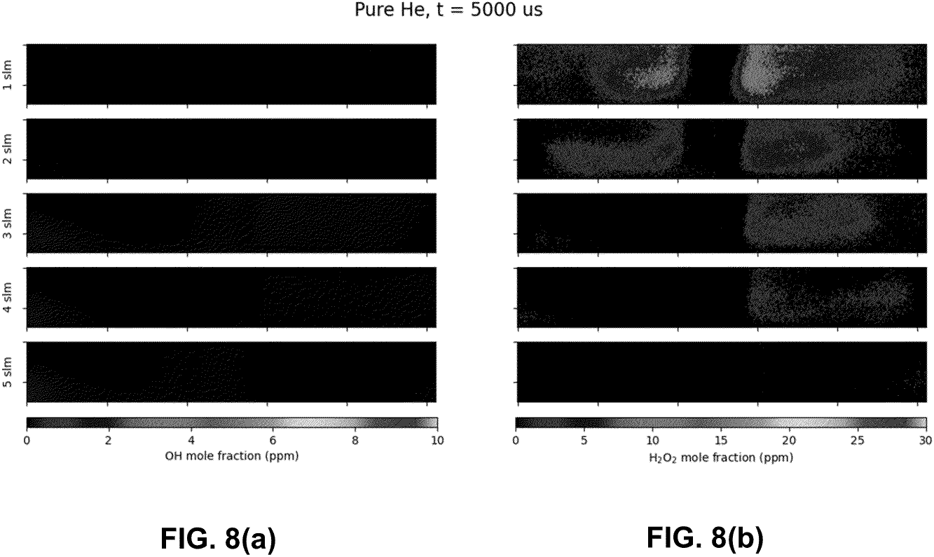

FIG. 8(a) illustrates discharge photographic graph results for OH mole fraction (ppm) along the x-axis thereof for pure He for 1 slm, 2 slm, 3 slm, 4 slm, and 5 slm flow rates, respectively, for time t = 5000 µs. Similarly, FIG. 8(b) illustrates discharge photographic graph results for H₂O₂ mole fraction (ppm) along the x-axis thereof for pure He for 1 slm, 2 slm, 3 slm, 4 slm, and 5 slm flow rates, respectively, for time t = 5000 µs.

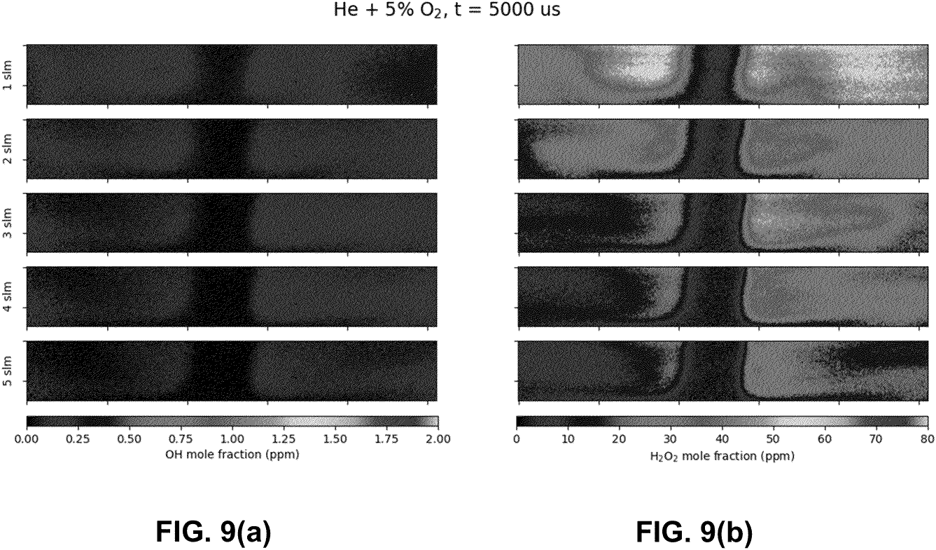

FIG. 9(a) illustrates discharge photographic graph results for OH mole fraction (ppm) along the x-axis thereof for He+5%O₂ for 1 slm, 2 slm, 3 slm, 4 slm, and 5 slm flow rates, respectively, for time t = 5000 µs. Similarly, FIG. 9(b) illustrates discharge photographic graph results for H₂O₂ mole fraction (ppm) along the x-axis thereof for He+5%O₂ for 1 slm, 2 slm, 3 slm, 4 slm, and 5 slm flow rates, respectively, for time t = 5000 µs.

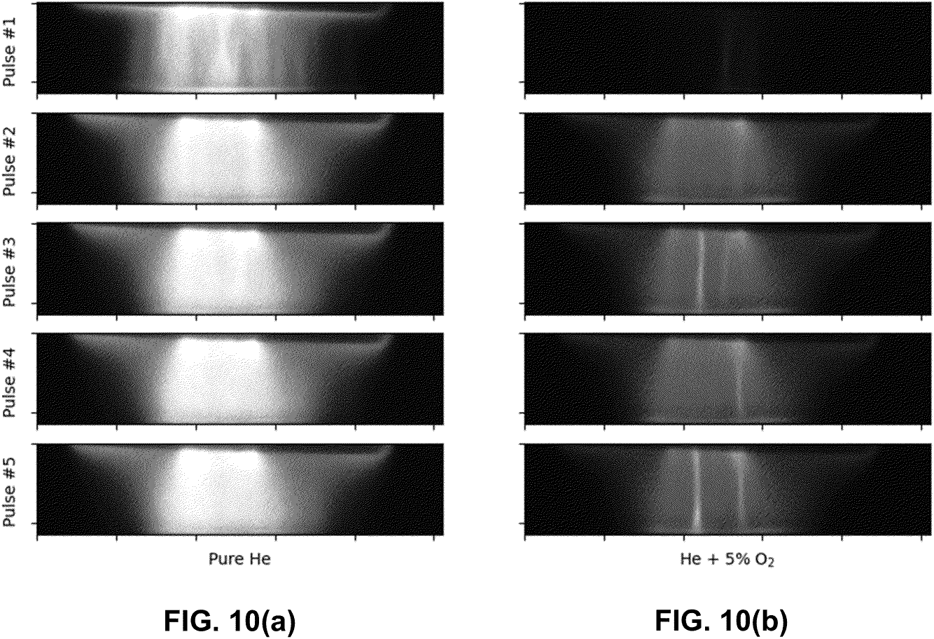

Lastly, FIG. 10(a) illustrates discharge photographic graph results for pure He at first through fifth pulses, respectively. Similarly, FIG. 10(b) illustrates discharge photographic graph results for He+5%O₂ at first through fifth pulses. respectively.

While certain embodiments of the disclosed subject matter have been described using specific terms, such description is for illustrative purposes only, and it is to be understood that changes and variations may be made without departing from the spirit or scope of the subject matter.

References

| | |
|---|---|
| 1. | Ceriani, E., E. Marotta, V. Shapoval, G. Favaro, and C. Paradisi, Complete mineralization of organic pollutants in water by treatment with air non-thermal plasma. Chemical Engineering Journal, 2018. 337: p. 567-575. |
| 2. | Ma, R., G. Wang, Y. Tian, K. Wang, J. Zhang, and J. Fang, Non-thermal plasma-activated water inactivation of food-borne pathogen on fresh produce. Journal of hazardous materials, 2015. 300: p. 643-651. |
| 3. | Penetrante, B., M. Hsiao, J. Bardsley, B. Merritt, G. Vogtlin, A. Kuthi, C. Burkhart, and J. Bayless, Identification of mechanisms for decomposition of air pollutants by non-thermal plasma processing. Plasma sources science and technology, 1997. 6(3): p. 251. |
| 4. | Baik, K.Y., H.L. Kang, J. Kim, S.Y. Park, J.Y. Bang, H.S. Uhm, E.H. Choi, and G. Cho, Non-thermal plasma jet without electrical shock for biomedical applications. Applied Physics Letters, 2013. 103(16): p. 164101. |
| 5. | Kalghatgi, S., C.M. Kelly, E. Cerchar, B. Torabi, O. Alekseev, A. Fridman, G. Friedman, and J. Azizkhan-Clifford, Effects of non-thermal plasma on mammalian cells. PloS one, 2011. 6(1): p. e16270. |
| 6. | Kim, Y.H., Y.J. Hong, K.Y. Baik, G.C. Kwon, J.J. Choi, G.S. Cho, H.S. Uhm, D.Y. Kim, and E.H. Choi, Measurement of reactive hydroxyl radical species inside the biosolutions during non-thermal atmospheric pressure plasma jet bombardment onto the solution. Plasma Chemistry and Plasma Processing, 2014. 34(3): p. 457-472. |
| 7. | Karuppiah, J., E.L. Reddy, P.M.K. Reddy, B. Ramaraju, R. Karvembu, and C. Subrahmanyam, Abatement of mixture of volatile organic compounds (VOCs) in a catalytic non-thermal plasma reactor. Journal of hazardous materials, 2012. 237: p. 283-289. |
| 8. | Magureanu, M., N.B. Mandache, and V.I. Parvulescu, Degradation of pharmaceutical compounds in water by non-thermal plasma treatment. Water research, 2015. 81: p. 124-136. |
| 9. | Vandenbroucke, A.M., R. Morent, N. De Geyter, and C. Leys, Non-thermal plasmas for non-catalytic and catalytic VOC abatement. Journal of hazardous materials, 2011. 195: p. 30-54. |
| 10. | Verreycken, T. and P.J. Bruggeman, OH density measurements in nanosecond pulsed discharges in atmospheric pressure N2—H2O mixtures. Plasma Sources Science and Technology, 2014. 23(1): p. 015009. |
| 11. | Verreycken, T., N. Sadeghi, and P.J. Bruggeman, Time-resolved absolute OH density of a nanosecond pulsed discharge in atmospheric pressure He—H2O— absolute calibration, collisional quenching and the importance of charged species in OH production. Plasma Sources Science and Technology, 2014. 23(4): p. 045005. |
| 12. | Du, Y., G. Nayak, G. Oinuma, Z. Peng, and P.J. Bruggeman, Effect of water vapor on plasma morphology, OH and H2O2 production in He and Ar atmospheric pressure dielectric barrier discharges. Journal of Physics D: Applied Physics, 2017. 50(14): p. 145201. |
| 13. | Verreycken, T., R. Van der Horst, A. Baede, E. Van Veldhuizen, and P. Bruggeman, Time and spatially resolved LIF of OH in a plasma filament in atmospheric pressure He—H2O. Journal of Physics D: Applied Physics, 2012. 45(4): p. 045205. |
| 14. | Ono, R. and T. Oda, OH radical measurement in a pulsed arc discharge plasma observed by a LIF method. IEEE Transactions on Industry applications, 2001. 37(3): p. 709-714. |
| 15. | Ono, R. and T. Oda, Measurement of gas temperature and OH density in the afterglow of pulsedpositive corona discharge. Journal of Physics D: Applied Physics, 2008. 41(3): p. 035204. |
| 16. | Bruggeman, P., D. Schram, M.Á. González, R. Rego, M.G. Kong, C.J.P.S.S. Leys, and Technology, Characterization of a direct dc-excited discharge in water by optical emission spectroscopy. 2009. 18(2): p. 025017. |
| 17. | Verreycken, T., R. Van Der Horst, N. Sadeghi, and P. Bruggeman, Absolute calibration of OH density in a nanosecond pulsed plasma filament in atmospheric pressure He—H2O— comparison of independent calibration methods. Journal of Physics D: Applied Physics, 2013. 46(46): p. 464004. |
| 18. | Bruggeman, P., G. Cunge, N.J.P.S.S. Sadeghi, and Technology, Absolute OH density measurements by broadband UV absorption in diffuse atmospheric-pressure He—H2O RF glow discharges. 2012. 21(3): p. 035019. |
| 19. | Kanazawa, S., H. Tanaka, A. Kajiwara, T. Ohkubo, Y. Nomoto, M. Kocik, J. Mizeraczyk, and J.-S. Chang, LIF imaging of OH radicals in DCpositive streamer coronas. Thin Solid Films, 2007. 515(9): p. 4266-4271. |
| 20. | Dilecce, G., P. Ambrico, M. Simek, and S. De Benedictis, LIF diagnostics of hydroxyl radical in atmospheric pressure He—H2O dielectric barrier discharges. Chemical physics, 2012. 398: p. 142-147. |
| 21. | Larsson, K., Development of photofragmentation-based diagnostics. 2018: Division of Combustion Physics, Department of Physics, Lund University. |
| 22. | Larsson, K., O. Johansson, M. Aldén, and J. Bood, Simultaneous visualization of water and hydrogen peroxide vapor using two-photon laser-induced fluorescence and photofragmentation laser-induced fluorescence. Applied Spectroscopy, 2014. 68(12): p. 1333-1341. |
| 23. | Johansson, O., J. Bood, M. Aldén, and U. Lindblad, Detection of hydrogen peroxide using photofragmentation laser-induced fluorescence. Applied spectroscopy, 2008. 62(1): p. 66-72. |
| 24. | Li, B., M. Jonsson, M. Algotsson, J. Bood, Z. Li, O. Johansson, M. Aldén, M. Tunér, and B. Johansson, Quantitative detection of hydrogen peroxide in an HCCI engine using photofragmentation laser-induced fluorescence. Proceedings of the Combustion Institute, 2013. 34(2): p. 3573-3581. |

What is claimed is:

1. A method for in-situ hydrogen peroxide production from water vapor and electricity, comprising:
providing an open plasma reactor assembly having a feed end and a plasma reaction end;
introducing a flow of a mixture of He and water (H₂O) into the assembly feed end; and
using high voltage pulses with the open plasma reactor assembly to produce hydrogen peroxide (H₂O₂) in a plasma discharge at the plasma reaction end.

2. The method according to claim 1, wherein both OH and H₂O₂ are produced in the discharge.

3. The method according to claim 1, wherein the open plasma reactor assembly includes an electrode configured for integration with a dielectric barrier plasma discharge driven by high voltage pulses.

4. The method according to claim 3, wherein the electrode comprises a mechano-chemical electrode comprising a powered copper cylinder housed concentrically in a compression sleeve, and receiving a mica cylinder in the copper cylinder, and the electrode further forms a concentric channel formed therethrough from the feed end to the plasma reaction end, to receive through the concentric channel the flow of the He—H₂O mixture.

5. The method according to claim 1, further comprising:
introducing a flow of O₂ with the mixture of He and water (H₂O) into the assembly feed end; and
wherein both OH and H₂O₂ are produced in the discharge.

6. The method according to claim 5, further comprising:
detecting and quantifying hydroxyl radicals (OH) and hydrogen peroxide (H₂O₂) produced in the discharge; and
wherein average OH concentration in the discharge is at least about 0.5 ppm and the concentration of H₂O₂ in the discharge is at least about 20 ppm.

7. The method according to claim 2, further comprising detecting and quantifying hydroxyl radicals (OH) and hydrogen peroxide (H₂O₂) produced in the discharge.

8. The method according to claim 7, further comprising using photo fragmentation laser-induced fluorescence (PFLIF) associated with the assembly plasma reaction end for detecting and quantifying hydroxyl radicals (OH) and hydrogen peroxide (H₂O₂) produced in the discharge.

9. The method according to claim 8, wherein the photo fragmentation laser-induced fluorescence (PFLIF) includes use of a photo dissociation laser beam and an excitation laser beam.

10. The method according to claim 7, further comprising calibrating the discharge production for OH and H₂O₂.

11. The method according to claim 10, wherein calibrating for H₂O₂ includes using a known concentration of H₂O₂ in He to calibrate for H₂O₂.

12. The method according to claim 10, wherein calibrating for OH includes using a chemical model.

13. Methodology for the production of reactive oxidizing species in a plasma discharge, comprising generating nonthermal plasma (NTP) discharges in the presence of water and He for in-situ production of hydrogen peroxide (H₂O₂) in the NTP discharge.

14. The methodology according to claim 13, further comprising using photo fragmentation laser-induced fluorescence (PFLIF) for detecting H₂O₂ in the NTP discharge.

15. The methodology according to claim 13, further comprising
providing an open plasma reactor assembly having an electrode with a feed end and a plasma reaction end, and configured for integration with a dielectric barrier plasma discharge driven by high voltage pulses;
introducing a flow of a mixture of He and water (H₂O) into the assembly feed end; and
using high voltage pulses with the open plasma reactor assembly to produce hydroxyl radicals (OH) and hydrogen peroxide (H₂O₂) in a plasma discharge at the plasma reaction end.

16. The methodology according to claim 15, wherein the electrode comprises a powered copper cylinder housed concentrically in a compression sleeve, and with a quartz dielectric fused to the copper adjacent the plasma reaction end, and the electrode further forms a concentric channel formed therethrough from the feed end to the plasma reaction end, to receive through the concentric channel the flow of the He—H₂O mixture.

17. The methodology according to claim 16, further comprising:
detecting and quantifying hydroxyl radicals (OH) and hydrogen peroxide (H₂O₂) produced in the discharge; and
wherein average OH concentration in the discharge is at least about 0.5 ppm and the concentration of H₂O₂ in the discharge is at least about 20 ppm.

18. The methodology according to claim 17, further comprising calibrating the discharge production for OH and H₂O₂.

19. A system for in-situ hydrogen peroxide production from water vapor and electricity, comprising:
an open plasma reactor assembly having a powered electrode having a feed end and a plasma reaction end;
a flow of a mixture of He and water (H₂O) controllably fed into the assembly feed end; and
a pulser for selectively providing high voltage pulses to the powered electrode for producing hydrogen peroxide (H₂O₂) in a plasma discharge at the electrode plasma reaction end.

20. The system according to claim 19, wherein high voltage pulses provided to the powered electrode further produces OH in the plasma discharge.

21. The system according to claim 19, wherein the electrode comprises a powered copper cylinder housed concentrically in a compression sleeve, and with a quartz dielectric fused to the copper adjacent the plasma reaction end, and the electrode further forms a concentric channel formed therethrough from the feed end to the plasma reaction end, to receive through the concentric channel the flow of the He—H2O mixture.

22. The system according to claim 19, further comprising:
a flow of O₂ combined with the mixture of He and water (H₂O) into the assembly feed end; and
wherein both OH and H₂O₂ are produced in the plasma discharge,
average OH concentration in the discharge is at least about 0.5 ppm, and
concentration of H₂O₂ in the discharge is at least about 20 ppm.

23. The system according to claim 20, further comprising:
laser spectrometer diagnostics for detecting and quantifying hydroxyl radicals (OH) and hydrogen peroxide (H₂O₂) produced in the discharge.

24. The system according to claim 23, wherein said laser spectrometer diagnostics further comprises photo fragmentation laser-induced fluorescence (PFLIF) lasers for detecting and quantifying hydroxyl radicals (OH) and hydrogen peroxide (H₂O₂) produced in the discharge.

25. The system according to claim 24, wherein the photo fragmentation laser-induced fluorescence (PFLIF) lasers includes a photo dissociation laser beam and an excitation laser beam.
